(19) United States
(12) Patent Application Publication
(10) Pub. No.: US 2006/0294007 A1
(43) Pub. Date: Dec. 28, 2006

(54) Methods for facilitating validation of financial transactions made through a wireless communication network

(75) Inventor: Serge Barthelemy, Beijing (CN)

Correspondence Address: BUCHANAN, INGERSOLL & ROONEY PC, POST OFFICE BOX 1404, ALEXANDRIA, VA, 22313-1404, US

(73) Assignee: Paycool international limited, Hong Kong S.A.R. (CN)

(21) Appl. No.: 10/567,431

(22) PCT Filed: Aug. 8, 2003
(86) PCT No.: PCT/CN03/00645

§ 371 Date: Feb. 6, 2006

(51) Int. Cl. G06Q 40/00

(52) U.S. Cl. 705/40

(57) ABSTRACT

A request for approval is sent to a payee, in a Simple Payment scenario, to accept or reject a transaction. A subscriber to the Financial Transaction Service has the ability to set up Special Lists of Financial Transaction Accounts which are submitted to Particular Rules to be applied when such accounts are involved in transactions with the subscriber's own account. Such particular rules are checked and implemented by a Transaction Processing Platform and/or by a mobile handset and/or the SIM of the subscriber. The Special Lists are stored in part or integrally in files connected to the Transaction Processing Platform and/or in memory of the mobile handset and or in a memory of the SIM. The Financial Transaction Account number of a subscriber can be read automatically by another subscriber. The validation of a Payment Request that is sent to a Payer for approval is facilitated by the display on his mobile handset of the Payee's name or logo or an easily recognizable sign or an audible message.

### TECHNICAL FIELD

The invention relates to wireless telecommunication systems, and more particularly to systems which enables to make financial transactions through a wireless communication network.

### BACKGROUND OF THE INVENTION

In the recent years digital wireless communication networks (GSM, CDMA) have enjoyed a great success, and have provided users with a range of new possibilities. New generations of networks like WCDMA, CDMA 2000, or TD-SCDMA which are starting to be deployed will be able offer many more capabilities to the users like video streaming etc. Digital mobile phones are also having more impressive features, increased processing power and memory and could be used for a wide range of applications, going far beyond voice, text communication or data transfer.

Despite all those capabilities of the networks or of the mobile phones, some applications like the ability to make payments through wireless communication network and with mobile phones have not emerged, and few attempts have proved to be too complex to implement.

This invention refers also to a previous patent application PCT/CN02/00301, describing a “SYSTEM TO ENABLE A TELECOM OPERATOR PROVIDE FINANCIAL TRANSACTIONS SERVICES AND METHODS FOR IMPLEMENTING SUCH TRANSACTIONS”.

The above mentioned patent application brings some solutions to the issue of executing financial transactions through wireless communication network and describes several methods for executing payment among which:

Simple Payment

Payment Request

In the Simple Payment transaction process, the payment is executed immediately upon receipt by the Transaction Processing platform, and the execution is notified to both parties, the Payer and the Payee. In some circumstances this could create a problem if the Payer is ill intentioned and the Payee is not willing to receive such payment. The present invention is bringing a solution to this potential problem.

In the Payment Request the Payee needs to know the Payer's account number in order to be able to send the Payment Request. This number is generally a 8 to 16 digit one and its manual capture may be uneasy or even a source of unwanted errors. The present invention is bringing a solution to this situation. Also, when the Payer receives a Payment Request from a Payee, the Payee's account number is displayed. In some circumstances it might not be easy, fast enough or comfortable for the Payer to identify or recognise the Payee just by his account number. The present invention is bringing a solution to this situation.

### SUMMARY OF THE INVENTION

The object of the present invention is to bring innovative improvements to the methods already described in the patent application PCT/CN02/00301, for the validation and execution of the financial transactions.

According to the invention, a request for approval is introduced and sent to the Payee, in a Simple Payment scenario, for him/her to decide to receive or not a payment on his/her Financial Transaction Account.

According to the invention a subscriber to the Financial Transaction Service, has the ability to set up Special Lists of Financial Transaction Accounts which are submitted to Particular Rules be applied when such accounts are involved in transactions with the subscriber's own account. According to the invention such particular rules are checked and implemented by the Transaction Processing Platform and/or by the mobile handset and/or the SIM of said subscriber. According to the invention the said Special Lists are stored in part or integrally in files connected to the Transaction Processing Platform and/or in a memory of the mobile handset and or in a memory of the SIM.

According to the invention, the Financial Transaction Account number of a subscriber can be read automatically by another subscriber by methods and means which are described in the invention.

According to the invention, the validation of a Payment Request that is sent to a Payer for approval, is facilitated by the display on his mobile handset of the Payee's name or logo or an easily recognisable sign or an audible message.

### BRIEF DESCRIPTION OF DRAWINGS

The invention will be described more in detail below with reference to the appended drawings, in which:

FIG. 1 is a representation of the process involved between the Payer, the Transaction Processing Platform and the Payee for a Simple Payment with a request for approval submitted to the Payee

FIG. 2 is an example of few representations of displays appearing on screens of mobile handset of the Payee or the Payer during some of the steps of Simple Payment process described in FIG. 1.

FIG. 3 is an example of representation of the Financial Transaction Account (FTA) number printed in clear and in barcode format, affixed on the back side of a mobile handset.

FIG. 4 is an example of representations of different ways to display the Payee (a famous supermarket chain) number, name and logo on a Payment request sent to a Payer.

### DETAILED DESCRIPTION OF PREFERRED EMBODIMENTS

In the patent application PCT/CN02/00301, two transaction scenarios and their respective process are described in great details; they are:

Scenario 1: Simple payment

Scenario 2: Payment request

Those two scenarios represent the most frequently used financial transaction scenarios.

The present invention brings additional innovative features and improvements to those processes, which are further described below.

### Scenario 1: Simple Payment

This scenario is typical of a peer to peer transaction where Payer “B” sends a payment to Payee “A”. Although it might not be usual, it may happen that on some occasions “A” is not willing to receive a certain sum of money from an unknown Payer in this case “B”.

In such case, “A” needs to have the possibility to reject an unwanted payment.

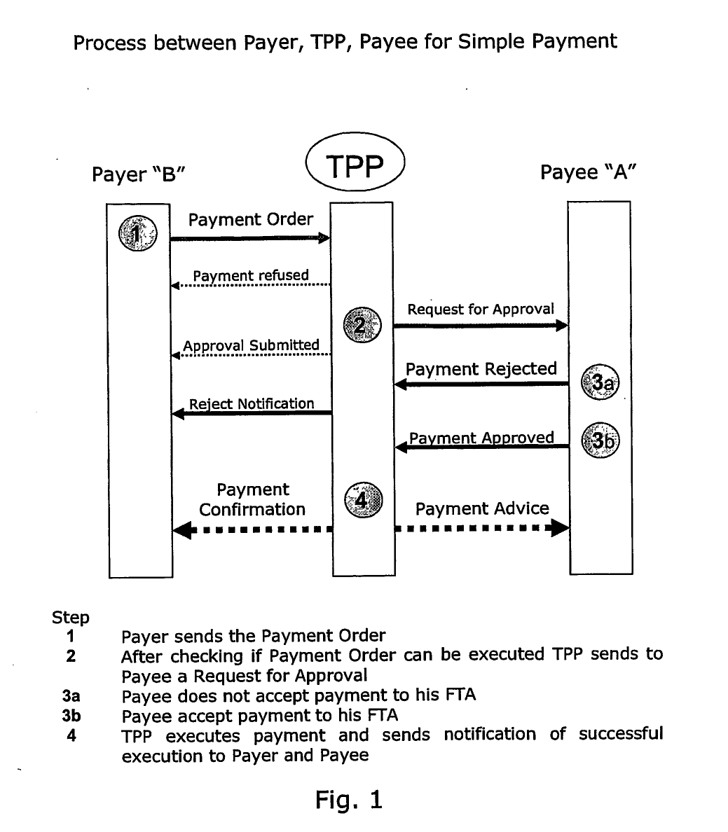

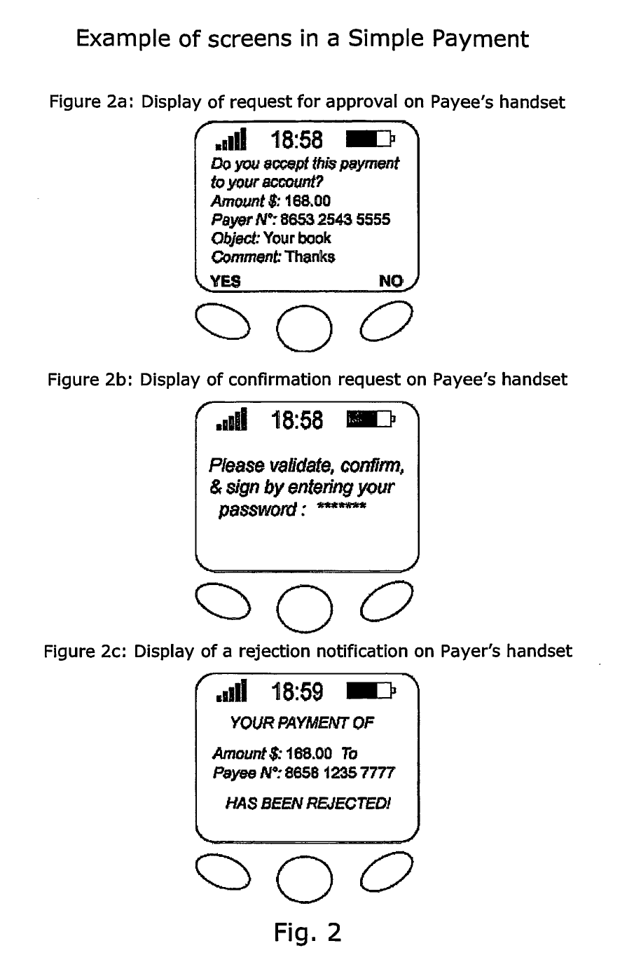

According to the invention, a step is included in the transaction process where by the Payee “A” is requested to approve or reject the payment on his/her Financial Transaction Account (FTA) sent by the Payer “B” (see FIG. 1). In one of the embodiment of the invention the Transaction Processing platform (TPP) sends to the Payee's mobile phone or connectable electronic device, an approval request which, as an example, can have the following content (see FIG. 2a):
Do you accept this payment to you account?
Amount: 168.00$
From Payer N^{o}: 8653 2543 5555
Object: your book
Comments: thanks

The Payee “A” is hence requested to answer YES or NO by pressing the corresponding key. Once the Payee “A” has pressed the key of his choice, he is prompted to Confirm/Validate/Sign by imputing his Password (see FIG. 2b) or by any of the other mean as described in the referred patent application PCT/CN02/00301.

According to the invention, the Mobile Transaction Management Software (MTMS), installed on the mobile handset or connectable electronic device or the SIM, is then generating a data file with the data of the proposed transaction, the Date & Time, the decision of the Payee “A” (i.e. approval or rejection), and the corresponding digital signature. This data file is then encrypted and sent to the TPP for execution.

Upon receipt of the Payee “A” decision, TPP will execute the transaction according to Payee's choice:

In case of approval payment is executed in favour of “A”, with the process described in patent application PCT/CN02/00301

In case of rejection, TPP will send a rejection notification to the Payer “B” which can have the following content (see FIG. 2c):

YOUR PAYMENT OF
Amount $: 168.00
To Payee N^{o}: 8658 1235 7777
HAS BEEN REJECTED!

This method is particularly interesting to protect people against ill intentioned financial transactions attempts (corruption, blackmail, etc . . . ); however in some cases the need for approving a payment receipt might not be justified or might even be annoying. This would be the case for example when payees are expecting the payment to arrive from known payers (relatives, friends, customers, etc . . . ).

In such case it is useful that the system be able to identify and distinguish transactions coming from accepted, unknown, or unwanted payers. According to such distinction the system will send or not a request for approval to the payee or even reject the transaction.

According to the invention, the system described in the patent application PCT/CN02/00301, provides the subscribers to the financial transaction service with the possibility of including in a Special List FTA numbers for which request for approval shall not be required.

But the notion of Special List can be further extended to other types of rules to bring additional advantages in controlling or validating transactions. A rule or a set of rules can be selected to define a Special List for a subscriber. Those rules are applied to the transactions between the subscriber (owner of the Special List) and the accounts included in the Special List. A subscriber can have one or several Special lists. In one embodiment of the invention the rules are checked and applied by the Transaction Processing Platform. In another embodiment of the invention the rules are checked and applied by the MTMS running on the mobile handset or on the SIM.

As examples, the following Special Lists are defined with their corresponding rules:

Default List: No particular rule

By default all accounts are included in the Default List. For those accounts no particular rule is applied.
   Green List: No request for approval required
If a subscriber includes some accounts in his/her Green List, then Simple Payment received from those accounts shall NOT require any request for approval (as described above) to be sent to the payee. The Simple Payment will be executed and notified to the parties as described in patent application PCT/CN02/00301.
   Black List: All transactions rejected
If a subscriber includes some accounts in his/her Black List, then no transaction is possible with those accounts.
   Red List: Receiving Simple Payment rejected only
If a subscriber includes some accounts in his/her Red List, then only Simple Payment coming from those accounts shall be rejected by the TPP without notifying the subscriber; however other types of transactions shall be possible with those accounts.
   Orange List: Sending Simple Payment rejected only
If a subscriber includes some accounts in his/her Orange List, then he/she shall not be able to send Simple Payment to those accounts; however other types of transactions shall be possible with those accounts.
   Blue List: No payment request accepted
If a subscriber includes some accounts in his/her Blue List, then Payment Request coming from those accounts shall be rejected by the TPP without notifying the subscriber; however other types of transactions shall be possible with those accounts.

The names of the lists are just given as examples.

It is also easily understandable that several other kinds of Special Lists may be created with a particular rule for a certain purpose. For example some lists might be created with the purpose of setting certain limited amounts in transactions with the accounts of the said list.

According to the invention, any subscriber to the Financial Transaction Service has the possibility to update (i.e. add and/or remove accounts) his/her Special Lists directly from his/her mobile handset or connectable electronic device.

According to the invention, a subscriber has the possibility to insert ALL existing Financial Transaction Accounts in a Special List. By doing so and then by having the possibility to remove a few ones among all, this provides a high degree of flexibility which can be easily understood. For example a father can have his child enrolled to the Financial Transaction Service and ask to have ALL accounts to be put in the Black List of his child, then he can remove some accounts from the Black List; as such the child will be able to make transactions only with a limited number of approved accounts.

The benefits of having such Special Lists available are easy to understand. For example a retailer whose preoccupation would be to speed up the payment process at his point of sale, and also to prevent the staff from making payments will put all FTA in Green List, in Orange List and in Blue List.

According to the invention, the various Special Lists mentioned above are at least stored in a database, or in dedicated files managed by, or interfaced with, the Transaction Processing Platform (TPP).

In another embodiment of the invention the Special Lists are also stored totally or in part in a memory of the mobile handset, or the connectable electronic device and/or in a memory of the Subscriber Identity Module (SIM, USIM, UIM or equivalent).

### Scenario 2: Payment Request

In this scenario, the Payee “A” is the initiator of the transaction when he/she sends a Payment Request to the Payer “B”. This scenario is particularly suitable in a retail environment, as it allows the retailer, for example, to send the transaction data to the customer and thus does not require the customer to key in the data to be able to make the payment. However this process requires the payee to capture and key in the payer's FTA number. FTA numbers have generally several digits (usually 8 to 16) and capturing, then keying in such account number can be a lengthy process as well as prone to unnoticeable errors; and capturing automatically the payer's FTA number shall bring great benefits.

According to the invention, the Payer's FTA number is stored in/on the Payer's handset in a form that can be read and captured by an automatic reading device connected to the mobile handset or the connectable electronic device of the Payee.

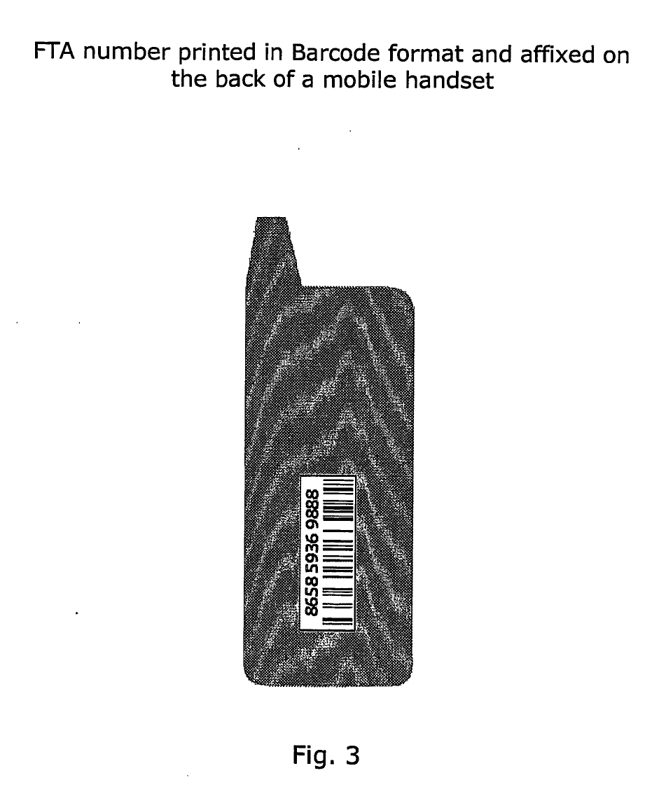

In one embodiment of the invention the Payer's FTA number is printed in barcode format on a sticker affixed on the back of the mobile handset (see FIG. 3). In this case, the Payee who has a barcode reader connected to his/her mobile handset or connectable electronic device, has just to get close to the Payer's mobile handset with the barcode reader and capture the Payer's FTA number. The Payee can then continue preparing the payment request as described in patent application PCT/CN02/00301.

In other embodiment of the invention, the FTA number is printed in a barcode format on a card that is presented to the Payee to be read automatically.

In another embodiment of the invention the FTA number is stored in the memory of a contactless electronic chip, which is affixed somewhere on or in the Payer's mobile handset or connectable electronic device. Such contactless chip can be read from a distance (generally several centimetres), through electromagnetic waves, by an adequate contactless reader which is connected to the mobile handset or connectable electronic device of the Payee.

In another embodiment of the invention the FTA number is stored in the memory of the SIM which has a contactless interface, and can be read by an adequate contactless reader which is connected to the mobile handset or connectable electronic device of the Payee.

In another embodiment of the invention the FTA number is read from the memory of the Payer's mobile handset or from the memory of the Payer's SIM, and sent through the Infra Red port of said handset to the Infra Red port of the payee's mobile handset or connectable electronic device.

In another embodiment of the invention the FTA number is read from the memory of the Payer's mobile handset or from the memory of the Payer's SIM, and sent through a short range radio interface (like BlueTooth, WiFi, or other) to the mobile handset or connectable electronic device of the Payee.

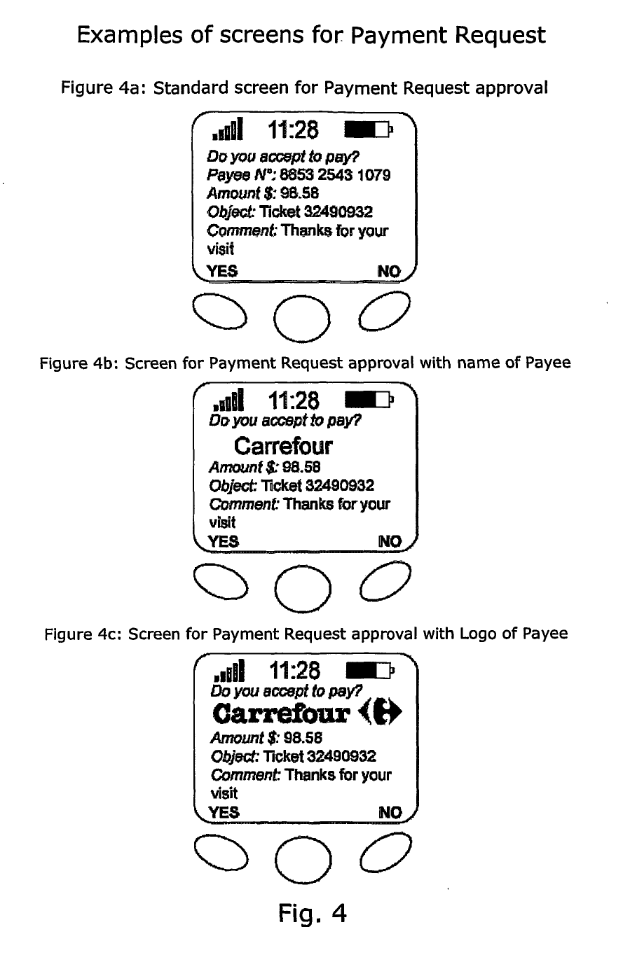

In the transaction process described in the patent application PCT/CN02/00301, when a Payer receives a Payment Request, the Payee is identified only by his FTA number (see FIG. 4a). In some circumstances this might induce some discomfort for the Payer as he/she must verify that this number matches with the one of the retailer. Further more, some people might try to use a lack of vigilance from the part of the Payer in verifying the retailer's FTA number, to send at the same moment another Payment Request to the same Payer in an attempt to get paid before the retailer's Payment Request is actually accepted. The invention brings a solution to such potential problem characterised in that when TPP is sending the Payment Request to the Payee, it will add a data that will be displayed in lieu of the Payee FTA number.

According to the invention, the said data display is easily or quickly recognisable by the Payer.

In one embodiment of the invention the said data display is the name or the brand of the Payee (see FIG. 4b).

In another embodiment of the invention the said data display is an image, a logo, an icon, or any other easily recognisable graphical mark (see FIG. 4c)

In another embodiment of the invention an audible message enabling to recognise easily the Payee is emitted by the Payer's mobile handset while the Payer is looking at the Payment Request.

The invention being thus described, it will be obvious that the same way be varied in many ways. Such variations are not to be regarded as a departure from the scope of the invention, and all such modifications as would be obvious to a person skilled in the art are intended to be included within the scope of the following claims.

1. A method for executing transactions in a system that enables financial transactions through a wireless communication network wherein a request for approval is sent to a payee's mobile handset or connectable electronic device, when a simple payment is sent by a payer to the payee.

2. A method according to claim 1 wherein the approval or rejection of payment by the payee is validated by inputting authentication data selected from the group comprising a password, finger print authentication, or authentication, and face authentication.

3. A method according to claim 1 wherein the approval or rejection decision is sent to a Transaction Processing Platform through the wireless communication network in a data file containing a digital signature of the content of the file.

4. A method according to claim 3 wherein the data file is encrypted before being sent.

5. A system that enables financial transactions through a wireless communication network, wherein a subscriber to the financial transaction service can open at least one special list of Financial Transaction Accounts associated with his/her own account.

6. A system according to claim 5 wherein financial transactions made with the accounts included in said special list follow at least one particular rule.

7. A system according to claim 6 wherein the particular rule or rules are checked and implemented by a Transaction Processing Platform.

8. A system according to claim 6 wherein the particular rule or rules are checked and implemented by at least one of a mobile handset or a connectable electronic device and/or a Subscriber Identity Module.

9. A system according to claim 5 wherein the subscriber can remove from his/her special list or add to his/her special list one or more accounts directly from his mobile handset or connectable electronic device, or by internet.

10. A system according to claim 5 wherein a subscriber can include in his/her special list all other Financial Transaction Accounts that exist in the system.

11. A system according to claim 7 wherein the all the existing special lists in the system are stored in a database or in files managed and/or interfaced with the Transaction Processing Platform.

12. A system according to claim 5 wherein the special lists of a subscriber are stored in part or in totality in a memory of his/her mobile handset or connectable electronic device, and/or in the memory of a Subscriber Identity Module.

13. A system according to claim 7 wherein the rule defining a special list is: no transaction allowed with accounts included in this special list.

14. A system according to claim 7 wherein the rule defining a special list is: no request for approval required in a simple payment transaction if payer's account is included in said special list.

15. A system according to claim 7 wherein the rule defining a special list is: only simple payments from accounts included in said special list shall be rejected.

16. A system according to claim 7 wherein the rule defining a special list is: no simple payment transaction shall be sent to accounts included in said special list.

17. A system according to claim 7 wherein the rule defining a special list is: no payment request from accounts included in said special list shall be accepted.

18. A system according to claim 7 wherein the rule defining a special list is a combination of at least two rules.

19. A system that enables financial transactions through a wireless communication network wherein a Financial Transaction Account number of a subscriber can be read automatically by another subscriber with an automatic reading method and/or device.

20. A system according to claim 19 wherein the Financial Transaction Account number is printed in a barcode format on a card.

21. A system according to claim 19 wherein the Financial Transaction Account number is printed in a barcode format on a sticker affixed on a mobile handset or a connectable electronic device.

22. A system according to claim 19 wherein the Financial Transaction Account number is sent to the other subscriber's mobile handset or connectable electronic device through an Infrared interface.

23. A system according to claim 19 wherein the Financial Transaction Account number is stored in a contactless electronic microcircuit, and can be read by a contactless reader.

24. A system according to claim 19 wherein the Financial Transaction Account number is stored in a Subscriber Identity Module which has a contactless Interface which can be read by a contactless reader.

25. A system according to claim 19 wherein the Financial Transaction Account number is sent to the other subscriber's mobile handset or connectable electronic device through a short range radio interface.

26. A Payment Request method in a system that enables financial transactions through a wireless communication network wherein, when displaying the request on a payer's mobile handset or connectable electronic device, the name or the brand of a payee is displayed instead of the payee's account number.

27. A Payment Request method in a system that enables financial transactions through a wireless communication network wherein, when displaying the request on a payer's mobile handset or connectable electronic device, the logo of a payee or an image chosen by the payee is displayed instead of the payee's account number.

28. A Payment Request method in a system that enables financial transactions through a wireless communication network wherein, when displaying the request on a payer's mobile handset or connectable electronic device, an audible message is broadcast by the payer's handset.
